(19) United States
(12) Patent Application Publication
(10) Pub. No.: US 2011/0200139 A1
(43) Pub. Date: Aug. 18, 2011

(54) MULTIPLE-INPUT MULTIPLE-OUTPUT SYSTEMS AND METHODS FOR WIRELESS COMMUNICATION THEREOF FOR REDUCING THE QUANTIZATION EFFECT OF PRECODING OPERATIONS UTILIZING A FINITE CODEBOOK

(76) Inventors: Yu-Chih JEN, Taoyuan County (TW); Ping-Cheng Yeh, Taoyuan County (TW); Ling-San Meng, Taoyuan County (TW); Pang-Chang Lan, Taoyuan County (TW); Chih-Yao Wu, Taoyuan County (TW)

(21) Appl. No.: 13/024,762

(22) Filed: Feb. 10, 2011

Related U.S. Application Data
(60) Provisional application No. 61/303,680, filed on Feb. 12, 2010.

(51) Int. Cl. H04L 25/03

(52) U.S. Cl. 375/296

(57) ABSTRACT

A method for reducing the quantization effect of precoding operations utilizing a finite codebook in multiple-input multiple-output (MIMO) or multiple-input single-output (MISO) systems from a transmitter to a receiver is provided. First, downlink channel state information is obtained at the receiver side. A set of indices of precoding matrices or a set of precoding matrices within the finite codebook are determined according to the obtained downlink channel state information at the receiver side. The selected indices of precoding matrices and a set of scalar coefficients are transmitted from the receiver to the transmitter. Thereafter, a refined precoding matrix is generated based on the set of indices of precoding matrices and the one or more scalar coefficients at the transmitter side. The refined precoding matrix is applied for transmission between the transmitter and the receiver.

### CROSS REFERENCE TO RELATED APPLICATIONS

This application claims priority of U.S. Provisional Application No. 61/303,680, filed on Feb. 12, 2010, and the entirety of which is incorporated by reference herein.

### BACKGROUND OF THE INVENTION

1. Field of the Invention

The invention generally relates to wireless communication systems and methods thereof, and more particularly, to methods for wireless communication for reducing the quantization effect of precoding operations utilizing a finite codebook in multiple-input multiple-output (MIMO) or multiple-input single-output (MISO) systems from a transmitter to a receiver.

2. Description of the Related Art

In wireless communications, multiple-input and multiple-output (MIMO) technology involves the use of multiple antennas at both the transmitter and receiver sides to improve communication performance. MIMO technology offers significant increases in data throughput and link ranges without additional bandwidth or transmit power via higher spectral efficiency and link reliability or diversity. One of the common functions in MIMO technology is precoding, which is a signal processing technique for MIMO communications to exploit the knowledge of the information of the downlink channel quality at the transmitter side. With precoding, the transmitter can transform signals using appropriate precoding matrices and perform power allocation adaptively according to the variation of link quality. It has been shown that precoding can substantially improve the spectral efficiency for MIMO communications.

Precoding is an effective technique improving the performance of MIMO-OFDM systems. In practical systems, the precoding matrices are pre-determined and only the index of the selected matrix is fed back.

Depending on the adopted criteria for assessing link performance, different objective functions exist for the computation of the optimal precoding matrix. For example, the minimum square error (MSE) and the achieved link capacity are two commonly adopted performance measures.

For the operation of precoding in MIMO communication systems, the information of the downlink channel quality generally has to be fed back from the receiver to the transmitter side. In general, precoding may require knowledge of channel state information (CSI) at the transmitter side. To achieve the optimal performance, the full information of the downlink channel quality or the optimal precoding matrix computed by the receiver has to be fed back to the transmitter side. Such signaling process incurs considerable overhead which scales with the number of antennas, i.e., the MIMO mode, and is undesirable in most cases. In current MIMO systems, the approach of codebook-based precoding is adopted to reduce the feedback overhead. In codebook-based precoding, a number of selected precoding matrices are known to both the transmitter side and receiver side prior to the transmissions. The receiver simply feeds back the index of the most preferred precoding matrix which yields the best performance based on the measured link quality and the objective function to the transmitter via the feedback channel. For example, if the number of precoding matrices is set to 2ⁿ, the length of the feedback can be n bits. Codebook-based precoding can substantially reduce the feedback overhead.

Ideally, the size of the codebook should be made as small as possible to reduce receiver complexity and the feedback overhead. However, the link performance is degraded with a small codebook size as the quantization error for the optimal precoding matrix increases in this case. Precoding gain in MIMO systems can be increased by increasing the size of the codebook. However, at the same time the complexity of codeword selection and memory requirements increase exponentially with the number of bits. A tradeoff thus exists when designing the precoder codebook.

### BRIEF SUMMARY OF THE INVENTION

Accordingly, embodiments of the invention provide methods for wireless communication for reducing the quantization effect of precoding operations utilizing a finite codebook in multiple-input multiple-output (MIMO) or multiple-input single-output (MISO) systems from a transmitter to a receiver. In one aspect of the invention, a method for wireless communication in an multiple-input multiple-output (MIMO) system is provided. First, downlink channel state information is obtained at a receiver side. A set of indices of precoding matrices or a set of precoding matrices within the finite codebook are determined according to the obtained downlink channel state information at the receiver side. The selected indices of precoding matrices and one or more scalar coefficients are transmitted from the receiver to the transmitter. Thereafter, a refined precoding matrix is generated based on the set of indices of precoding matrices and the one or more scalar coefficients at the transmitter side. The refined precoding matrix is applied for transmission between the transmitter and the receiver.

In another aspect of the invention, an MIMO system is provided which comprises a receiver and a transmitter. The receiver obtains downlink channel state information of a wireless channel, selects a set of indices of precoding matrices or a set of precoding matrices within a finite codebook according to the obtained downlink channel state information and transmits the selected indices of precoding matrices and a set of scalar coefficients. The transmitter is coupled to the receiver and is used for receiving the selected indices of precoding matrices and a set of scalar coefficients, generating a refined precoding matrix based on the set of indices of precoding matrices and the one or more scalar coefficients at the transmitter side, and applying the refined precoding matrix for transmission between the transmitter and the receiver.

Other aspects and features of the present invention will become apparent to those with ordinarily skill in the art upon review of the following descriptions of specific embodiments of apparatuses and methods for handling a network initiated detachment procedure.

### BRIEF DESCRIPTION OF DRAWINGS

The invention can be more fully understood by reading the subsequent detailed description and examples with references made to the accompanying drawings, wherein:

FIG. 1 is a block diagram illustrating a wireless communications system according to an embodiment of the invention;

FIG. 2 is a flow chart illustrating a method for reducing the quantization effect of precoding operations utilizing a finite codebook in MIMO or multiple-input single-output (MISO) systems from a transmitter to a receiver according to an embodiment of the invention; and

FIG. 3 is a schematic illustrating an example for determining one or more scalar coefficients in the precoding operations based on a set of indices of precoding matrices within the finite codebook and generating a refined precoding matrix based on the set of indices of precoding matrices and the one or more scalar coefficients according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense.

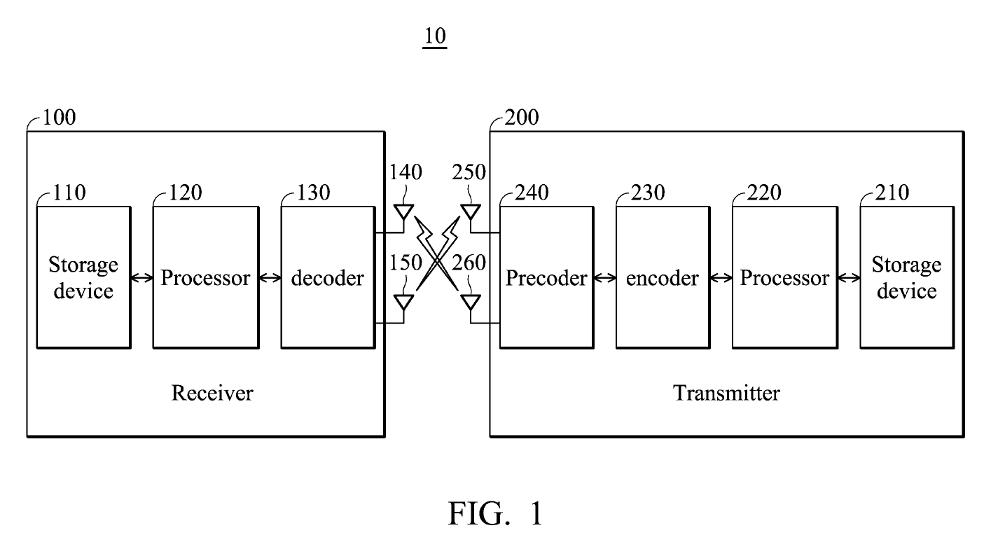

FIG. 1 is a block diagram illustrating a wireless communications system according to an embodiment of the invention. Particularly, the wireless communications system 100 is a multiple-input multiple-output (MIMO) system and comprises at least a transmitter 200 and a receiver 100. The receiver 100 is wirelessly connected to the transmitter 200 for obtaining wireless services. Generally, the transmitter 200 may be a network/base station, a user equipment (UE) or a mobile station while the receiver 100 may be a UE, a mobile station or a network/base station. For example, the receiver 100 may be a mobile station and the transmitter 200 may be its serving base station. For downlink (DL) transmission, signals are transmitted from the transmitter 200 to the receiver 100. On the transmitter side, the transmitter 200 (e.g., a base station) may comprise a storage device 210, a processor 220, a multiple-input multiple-output (MIMO) encoder 230 that encodes MIMO signals, a precoder 240 for performing precoding operations to precode the encoded signals and multiple antennas 250 and 260. On the receiver side, the receiver 100 may comprise a storage device 110, a processor 120, an MIMO decoder 130 that decodes MIMO signals and multiple antennas 140 and 150.

It is to be noted that, for the precoding operation, the information of the downlink channel quality (e.g. the channel state information (CSI)) has to be fed back from the receiver 100 to the transmitter 200 in the form of limited quantized feedback, where the quantization points may be referred to as precoding codewords or precoding matrices and the set of codewords or precoding matrices form a precoding codebook. The precoding codebook may be predefined in the storage device 210 or configurable by the transmitter 200. The precoding codebook may be broadcasted by the transmitter 200 or the receiver 100 through, for example, system information, but it is not limited thereto. The storage device 110 of the receiver 100 may also store a precoding codebook with a set of predefined codewords or precoding matrices as same as those predefined in the storage device 210.

The receiver 100 may then transmit a set of indices of precoding matrices or a set of precoding matrices and one or more scalar coefficient(s) to the transmitter 200 through data signaling or control signaling.

In some embodiments, the precoding codebook may be transmitter specific or receiver specific. In one embodiment, the transmitter 200 and/or the receiver 100 may further be configured in a specific transmission mode for applying precoding operations of the invention.

The transmitter 200 may receive the set of indices of precoding matrices and one or more scalar coefficients from the receiver 100 and generate a refined precoding matrix that is to be combined with a data signal and apply the refined precoding matrix for transmission, e.g, to precode the data signal according to the set of indices of precoding matrices and the one or more scalar coefficients. For example, in one embodiment, the transmitter 200 may obtain a set of precoding matrices from a finite codebook according to the set of indices of precoding matrices and apply a specific mathematics method with obtained precoding matrices and the one or more scalar coefficients, such as by interpolating between the obtained precoding matrices using the one or more scalar coefficients, to generate the refined precoding matrix. In some embodiments, the transmitter 200 may also generate the refined precoding matrix based on channel condition, transmission power, or other information regarding the receiver 100.

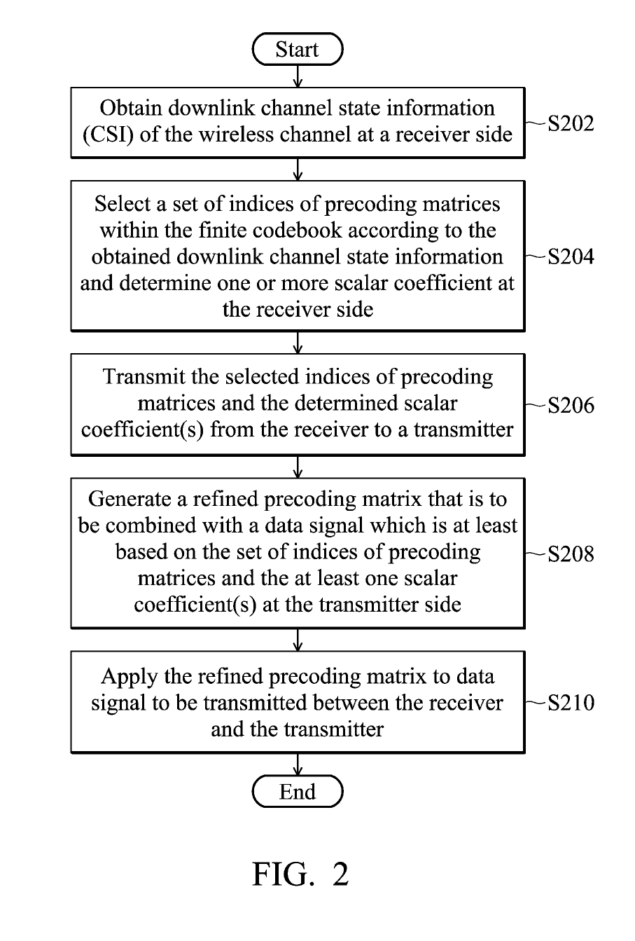

FIG. 2 is a flow chart illustrating a method for reducing the quantization effect of precoding operations utilizing a finite codebook in MIMO systems from a transmitter to a receiver according to an embodiment of the invention. The method can be applied to an MIMO wireless communication system as shown in FIG. 1. In this embodiment, the receiver 100 is wirelessly connected to the transmitter 200 which initiates a precoding operation via a wireless channel. First, in step S202, the receiver 100 obtains downlink channel state information (CSI) of the wireless channel through the decoder 130. After obtaining the downlink channel state information, in step S204, the receiver 100 selects a set of indices of precoding matrices within the finite codebook according to the obtained downlink channel state information and determines the one or more scalar coefficients through the decoder 130. Note that the receiver 100 may select a number of indices of precoding matrices within the finite codebook. For example, the receiver 100 may select two indices of precoding matrices within the finite codebook which are the indices of the best and second best matrices among the precoding matrices.

After the set of indices of precoding matrices has been selected and the one or more scalar coefficients has been determined, in step S206, the receiver 100 transmits the selected indices of precoding matrices and the determined scalar coefficient(s) to the transmitter 200 through the decoder 130. Upon reception of the set of selected indices of precoding matrices and the determined scalar coefficient(s), in step S208, the transmitter 200 generates a refined precoding matrix that is to be combined with a data signal which is at least based on the set of indices of precoding matrices and the one or more scalar coefficients. After the refined precoding matrix has been generated, in step S210, the transmitter 200 applies the refined precoding matrix to data signals to be transmitted between the receiver 100 and the transmitter 200, e.g, to precode the data signals.

The one or more scalar coefficients may be determined based on the set of indices of precoding matrices or the set of precoding matrices. In one embodiment, the set of indices of precoding matrices or the set of precoding matrices may form a subspace and the one or more scalar coefficient(s) may be obtained by computing the projection of the optimal precoding matrix onto the subspace spanned by the set of indices of precoding matrices or the set of precoding matrices. The distance between the precoding matrices such as the chordal distance, the projection 2-norm distance or the Fubini-Study distance may be applied to obtain the projection.

In some embodiments, the one or more scalar coefficients may be obtained by directly performing a numerical search such that the matrix distance between the precoding matrices and the optimal precoding matrix is minimized.

Because the refined precoding matrix is newly generated which is expected to reduce the quantization error, the refined precoding matrix introduces less quantization effect as compared with any single precoding matrix within the codebook.

It is to be noted that the number of indices of precoding matrices or precoding matrices in the set of indices of precoding matrices or precoding matrices is at least one. The one or more scalar coefficients may be represented by a field of a fixed size in the data signaling or control signaling format. In some embodiments, there may be a field in the data signaling or control signaling format to indicate the number of indices of precoding matrices or precoding matrices for the set of indices of precoding matrices or precoding matrices. Similarly, in some embodiments, there may be a field in the data signaling or control signaling format to indicate the number of scalar coefficients. In some embodiments, the number of indices of precoding matrices or precoding matrices in the set of indices of precoding matrices or precoding matrices and the number of scalar coefficients for the scalar coefficients are predefined.

For explanation, one specific embodiment is illustrated in the following to explain the detailed process of a method for multi-user detection of the invention, and those skilled in the art will understand that this specific embodiment is used for explanation only and the invention is not limited thereto.

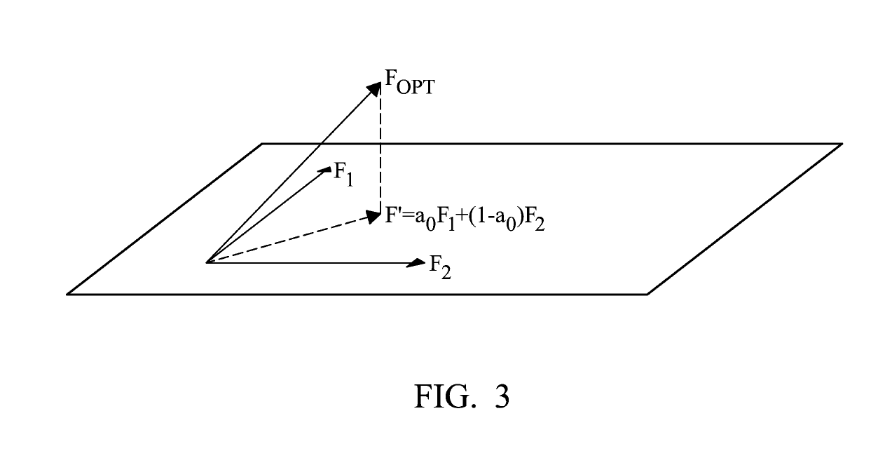

FIG. 3 is a schematic illustrating an example for determining one or more scalar coefficients in the precoding operations based on a set of indices of precoding matrices within the finite codebook and generating a refined precoding matrix based on the set of indices of precoding matrices and the one or more scalar coefficients according to another embodiment of the invention. Please refer to FIG. 3. In this embodiment, two precoding matrix indices along with one coefficient are provided to the transmitter 200 for generating a refined precoding matrix. In FIG. 3, for a particular channel realization and performance criterion, the best and the second-best precoding matrices within a given codebook can be determined and denoted by F₁ and F₂ respectively. Further, the optimal precoding matrix corresponding to the aforementioned channel realization and performance criterion is denoted by Fₒₚₜ. The optimal precoding matrix Fₒₚₜ may be determined by, for example, the minimum square error (MSE) or the achieved link capacity measurement for all of the precoding matrices within the given codebook. The coefficient, denoted by a₀, can be thus determined by the following formula:

a₀=argminₐd(Fₒₚₜ,aF₁+(1−a)F₂) (2),

where d( ) calculates the distance between two matrices and where a is a parameter ranged from 0 to 1 for determining whether the matrix distance between the precoding matrices F₁, F₂ and the optimal precoding matrix Fₒₚₜ is minimized Based on the adopted performance criterion and the codebook design rule, different definitions of a matrix distance can be applied, e.g., the chordal, Fubini-Study or projection 2-norm distances. In one embodiment, the coefficient a₀ may also be obtained by computing the projection of the optimal precoding matrix Fₒₚₜ onto the subspace spanned by the set of indices of precoding matrices or the set of precoding matrices F₁ and F₂, wherein the matrix distance such as the chordal distance, the projection 2-norm distance or the Fubini-Study distance may be applied to obtain the projection.

By sending F₁, F₂, and a₀ to the transmitter 200, a refined precoding matrix F′=a₀ F₁+(1−a₀) F₂ with less quantization effect as compared to the best precoding matrix F₁ within the codebook can be generated to precode data signals to be transmitted between the transmitter and the receiver.

In summary, according to the method for wireless communication in an MIMO system of the invention, the receiver is allowed to feed back multiple indices of the precoding matrices using a finite codebook along with some auxiliary information related to the geometric structure among the precoding matrices to the transmitter such that a refined precoding matrix which is expected to reduce the quantization error can be generated at the transmitter side, thus, reducing the quantization effect of precoding operations. Moreover, with the method for wireless communication in an MIMO system of the invention, the degree of freedom in generating precoding matrices and thus the quantization effect can be largely improved even with a small codebook.

Methods for wireless communication in an MIMO system and systems thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for wireless communication in a multiple-input multiple-output (MIMO) system, comprising:
obtaining downlink channel state information at a receiver side;
selecting a set of indices of precoding matrices or a set of precoding matrices within the finite codebook according to the obtained downlink channel state information at the receiver side;
transmitting the selected indices of precoding matrices and one or more scalar coefficients from the receiver to a transmitter;
generating a refined precoding matrix based on the set of indices of precoding matrices and the one or more scalar coefficients at the transmitter side; and
applying the refined precoding matrix to precode data signals to be transmitted between the transmitter and the receiver to reduce the quantization effect of precoding operations.

2. The method of claim 1, wherein the one or more scalar coefficients is determined based on the set of indices of precoding matrices or the set of precoding matrices.

3. The method of claim 2, wherein the one or more scalar coefficients is determined by calculating a projection of an optimal precoding matrix onto a subspace spanned by the set of indices of precoding matrices or the set of precoding matrices;
wherein the projection is represented by a distance between the precoding matrices.

4. The method of claim 3, wherein the one or more scalar coefficients is determined by directly performing a numerical search to minimize the matrix distance between the set of precoding matrices.

5. The method of claim 1, wherein the codebook is predefined or configurable by the transmitter;
the number of the scalar coefficients is predefined; and
the number of the set of indices of precoding matrices or the set of precoding matrices scalar coefficients is predefined.

6. A multiple-input multiple-output (MIMO) system, comprising:
a receiver, obtaining downlink channel state information of a wireless channel,
selecting a set of indices of precoding matrices or a set of precoding matrices within a finite codebook according to the obtained downlink channel state information and transmitting the selected indices of precoding matrices and a set of scalar coefficients; and
a transmitter coupled to the receiver, receiving the selected indices of precoding matrices and a set of scalar coefficients, generating a refined precoding matrix based on the set of indices of precoding matrices and the one or more scalar coefficients at the transmitter side, and applying the refined precoding matrix to precode data signals to be transmitted between the transmitter and the receiver to reduce the quantization effect of precoding operations.

7. The system of claim 6, wherein the one or more scalar coefficients are determined based on the set of indices of precoding matrices or the set of precoding matrices.

8. The system of claim 7, wherein the one or more scalar coefficients are determined by calculating a projection of an optimal precoding matrix onto a subspace spanned by the set of indices of precoding matrices or the set of precoding matrices.

9. The system of claim 8, wherein the projection is represented by a distance between the set of precoding matrices.

10. The system of claim 8, wherein the one or more scalar coefficients are determined by directly performing a numerical search to minimize the matrix distance among the set of precoding matrices and the optimal precoding matrix.

11. The system of claim 6, wherein the codebook is predefined or configurable by the transmitter.

12. The system of claim 6, wherein the number of the one or more scalar coefficients is predefined.

13. The system of claim 6, wherein the number of the set of indices of precoding matrices or the set of precoding matrices scalar coefficients is predefined.

14. The system of claim 6, wherein the transmitter is a network/base station or user equipment while the receiver is a user equipment or network/base station.

15. A receiver coupled to a transmitter via a wireless channel in an MIMO wireless communication system, comprising:
a decoder, obtaining downlink channel state information of the wireless channel, selecting a set of indices of precoding matrices or a set of precoding matrices within a finite codebook according to the obtained downlink channel state information, and transmitting the selected indices of precoding matrices and one or more scalar coefficients to the transmitter via the wireless channel such that the transmitter, upon receiving the selected indices of precoding matrices and a set of scalar coefficients, generates a refined precoding matrix based on the set of indices of precoding matrices and the one or more scalar coefficients, and applies the refined precoding matrix for transmission between the transmitter and the receiver.

16. The receiver of claim 15, wherein the one or more scalar coefficients are determined based on the set of indices of precoding matrices or the set of precoding matrices.

17. The receiver of claim 16, wherein the one or more scalar coefficients are determined by calculating a projection of an optimal precoding matrix onto a subspace spanned by the set of indices of precoding matrices or the set of precoding matrices.

18. The receiver of claim 17, wherein the projection is represented by a distance between the set of precoding matrices.

19. The receiver of claim 17, wherein the one or more scalar coefficients are determined by directly performing a numerical search to minimize the matrix distance among the set of precoding matrices and the optimal precoding matrix.

20. The receiver of claim 15, wherein the number of the set of indices of precoding matrices or the set of precoding matrices scalar coefficients is predefined.
